(19) United States
(12) Patent Application Publication
(10) Pub. No.: US 2025/0127257 A1
(43) Pub. Date: Apr. 24, 2025

(54) PRESSURE SENSITIVE DECAL

(71) Applicant: eMCee Apparel, L.L.C., New York, NY (US)

(72) Inventor: Marissa Confair, New York, NY (US)

(21) Appl. No.: 18/492,037

(22) Filed: Oct. 23, 2023

(51) Int. Cl. A43B 3/00; B32B 7/06; B32B 7/12; B32B 27/06; C09J 7/22; C09J 7/38; C09J 7/40

(52) U.S. Cl. CPC A43B 3/0078; B32B 7/06; B32B 7/12; B32B 27/06; C09J 7/22; C09J 7/38; C09J 7/405; B32B 2307/748; B32B 2323/00; B32B 2437/02; B32B 2451/00

(57) ABSTRACT

The disclosure relates to a pressure sensitive decal having an alignment application system.

### BACKGROUND

Footwear has provided a way to express one's style, and in recent years, has become progressively customized with decals. Typically, these decals may be adhered to a shoe, via heat guns and/or dangerous adhesives. Moreover, these conventional decals generally do not remain on the shoe for an extended period of time, nor are they reusable. When these decals are eventually removed from the shoe, the adhesive from the decals may damage the exterior material of the shoe.

Further, conventional decals are generally thin in an attempt to fit smoothly along the contours and various elevated surfaces of the shoe. However, when applying these decals to the shoe, areas of the decals tend to wrinkle or become stuck to one another. Further, as the shapes of the decals become more intricate, smaller, and/or irregularly shaped, the areas of the decals more frequently wrinkle and/or stick to one another, thereby increasing the difficulty of applying and accurately aligning the decal to particular areas of the shoe.

### SUMMARY

The disclosure relates generally to pressure sensitive decals, and more particularly, pressure sensitive decals having an alignment application system.

In one aspect, the disclosed technology relates to pressure sensitive decal configured to adhere to footwear. In one or more cases, the pressure sensitive decal includes a flexible three-dimensional material formed in a shape. The rear surface of the material includes a pressure sensitive adhesive configured to removably couple the material to one or more surfaces of the footwear. In one or more cases, the pressure sensitive decal includes a backing removably coupled to a rear surface of the material via the pressure sensitive adhesive. The backing is configured to maintain adhesive characteristics of the pressure sensitive adhesive. In one or more cases, the material is configured to adhere and conform to one or more surfaces of the footwear, such that the material lies smoothly along the one or more surfaces without deforming the shape of the decal. In one or more cases, the one or more surfaces comprise one or more types of materials.

In another aspect, the disclosed technology relates to a decal alignment application system. In one or more cases, the decal alignment application system includes a first layer, a second layer, a decal layer, and a backing layer. In one or more cases, the first layer includes a flexible non-stick material permanently coupled to a second layer. In one or more cases, the second layer has a first surface coated in an adhesive that permanently couples the second layer and the first layer. In one or more cases, the second layer has a second surface coated in an adhesive that temporarily bonds the second layer and a decal layer. In one or more cases, the decal layer includes a material layer and an adhesive layer. In one or more cases, the material layer includes a flexible three-dimensional material formed in a shape of a decal. In one or more cases, the adhesive layer includes a pressure sensitive adhesive configured to removably couple to a backing layer. In one or more cases, the backing layer is removably coupled to the adhesive layer of the decal layer and is configured to maintain adhesive characteristics of the pressure sensitive adhesive of the adhesive layer. In one or more cases, the material layer is configured to adhere and conform, via the adhesive layer, to one or more surfaces of footwear, such that the material layer lies smoothly along the one or more surfaces without deforming the shape of the decal.

In another aspect, the disclosed technology relates to a decal alignment application system. In one or more cases, the decal alignment application system includes a first layer, a decal layer, and a backing layer. In one or more cases, the first layer includes a flexible material. In one or more cases, the first layer has a second surface coated in an adhesive that temporarily bonds the first layer and a decal layer. In one or more cases, the decal layer includes a material layer and an adhesive layer. In one or more cases, the material layer includes a flexible three-dimensional material formed in a shape of a decal. In one or more cases, the adhesive layer includes a pressure sensitive adhesive configured to removably couple to a backing layer. In one or more cases, the backing layer is removably coupled to the adhesive layer of the decal layer and is configured to maintain adhesive characteristics of the pressure sensitive adhesive of the adhesive layer. In one or more cases, the material layer is configured to adhere and conform, via the adhesive layer, to one or more surfaces of footwear, such that the material layer lies smoothly along the one or more surfaces without deforming the shape of the decal.

The summary of the disclosure is given to aid understanding of decals, and in particular, pressure sensitive decals, and not with an intent to limit the disclosure. The present disclosure is directed to a person of ordinary skill in the art. It should be understood that various aspects and features of the disclosure may advantageously be used separately in some instances, or in combination with other aspects and features of the disclosure in other instances. Accordingly, it is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The following drawings are illustrative of embodiments of the present disclosure and therefore do not limit the scope of the present disclosure.

FIG. 1 illustrates a perspective view of example pressure sensitive decals applied to a shoe.

FIG. 2 illustrates a perspective view of an alignment application system including an example decal.

FIG. 3A illustrates an example cross-sectional side view of the example alignment application system of FIG. 2.

FIG. 3B illustrates an example cross-sectional side view of the example alignment application system of FIG. 2

FIGS. 4A and 4B illustrate an example application of applying the example decal to an object via the example alignment application system of FIGS. 2, 3A and 3B.

### DETAILED DESCRIPTION

The following discussion omits or only briefly describes conventional features of pressure sensitive decals, which are apparent to those skilled in the art. It is noted that various embodiments are described in detail with reference to the drawings, in which like reference numerals represent like drawing elements throughout the figures. Reference to various embodiments does not limit the scope of the claims attached hereto. Additionally, any examples set forth in this specification are intended to be non-limiting and merely set forth some of the many possible embodiments for the appended claims. Further, particular features described herein can be used in combination with other described features in each of the various possible combinations and permutations. Moreover, the drawings are not to scale and are intended for use in conjunction with the explanations in the following detailed description. The objectives and advantages of the claimed subject matter will become more apparent from the following detailed description of these embodiments in connection with the accompanying drawings.

Unless otherwise specifically defined herein, all terms are to be given their broadest possible interpretation including meanings implied from the specification as well as meanings understood by those skilled in the art and/or as defined in dictionaries, treatises, etc. It must also be noted that, as used in the specification and the appended claims, the singular forms “a,” “an,” and “the” include plural referents unless otherwise specified, and that the terms “comprises” and/or “comprising,” when used in this specification, specify the presence or addition of one or more other features, aspects, steps, operations, elements, components, and/or groups thereof. Further, relative terms, such as, “lower,” “upper,” “horizontal,” “vertical,” “above,” “below.” “up.” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movably or rigidly attached, unless expressly described otherwise.

Embodiments of the disclosure relate generally to pressure sensitive decals, and more particularly, pressure sensitive decals having an alignment application system. Embodiments that provide a pressure sensitive decal having an alignment application system are described below with reference to the figures.

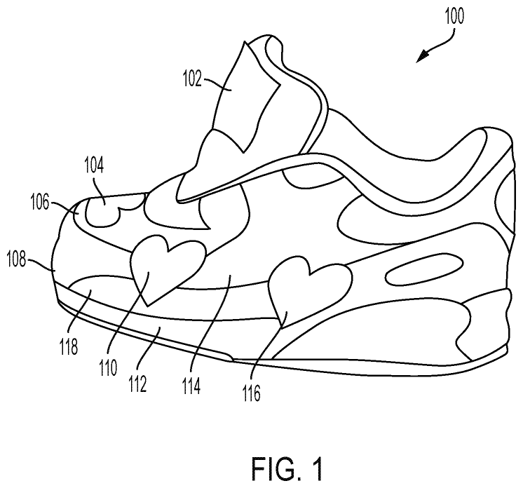

FIG. 1 illustrates a perspective view of example pressure sensitive decals 104, 110, and 116 applied to a shoe 100. The shoe 100 includes conventional features, such as, but not limited to, a tongue 102, vamp 106, toe cap 108, sole 112, a quarter panel 114, and a quarter panel overlay 118. The shoe 100 may be, for example, a sneaker, but can be any another type of shoe.

In one or more cases, the decal, such as decals 104, 110, and 116, may be a wearable decorative three-dimensional patch. Although the examples described herein relate to the decal being applied to a shoe, it is noted that the decal may be applied to other apparel, such as, but not limited to, clothing, fashion accessories, drinkware, bags, hats, and the like. The decal may be formed from a material, such as, but not limited to leather, faux and/or vegan leather, synthetic leather, suede, vinyl, canvas, flexible plastic, rubber, and/or foam materials, such as polyurethane, low-density polyethylene, thermal plastic rubber, ethylene-vinyl acetate, and the like.

In one or more cases, the material of the decal may be flexible enough to conform to the various contours and elevated surfaces of the shoe 100. Yet, the material of the decal may be rigid enough such that the decal may lie smoothly along the various surfaces and materials of the shoe 100 without bunching or wrinkling. The decal, such as decal 104, may lie flat on a surface, such as the surface of the vamp 106, of the shoe 100. Typically, the vamp 106 may repeatedly crease as a user moves in the shoe 100. As such, the decal 104 may flex to the shape of the vamp 106 as the vamp 106 creases and may return to form when the vamp 106 returns to its original position, thereby maintaining its smooth and contoured appearance on the shoe 100. In another example, the decal, such as decal 110, may be flexible enough conform and adhere to a variety of surface planes and materials of the shoe 100. For instance, a portion of the decal 110 may be adhered to the vamp 106, another portion of the decal 110 may be adhered to the toe cap 108, and another portion of the decal 110 may be adhered to the quarter panel overlay 118. As such, the decal 110 may be formed to adhere to the substantially horizontal surface of the vamp 106 and to the substantially vertical surface of the toe cap 108 and quarter panel overlay 118. In yet another example, the decal, such as decal 116, may be flexible enough to conform and adhere to elevated surfaces of the shoe 100. For instance, the quarter panel 114, quarter panel overlay 118, and sole 112 may be assembled together such that the surface of one or more of these shoe components are not level with one another. For instance, the surface of the quarter panel overlay 118 may extend farther from the shoe 100 than the surface of the quarter panel 114. The decal 116 may be contoured to lie on each elevated surface of the components of the shoe 100.

The shape of the decal may be formed by, for example, but not limited to, die cutting, laser cutting, and other like cutting processes that correspond to the type of material of the decal. For instance, a die cutting process may be used to form the decal shape in leather or vegan leather material. In another instance, a laser cutting process and/or die cutting process may be used to form the decal shape in polyurethane material.

In one or more cases, adhesive may be applied to the rear surface of the decal. The adhesive may be, for example, but not limited to, a pressure sensitive adhesive. In one or more cases, prior to forming the shape of the decal, the adhesive may be applied to the rear surface of a sheet of material used to form the decal. Having applied the adhesive, a layer of material, such as wax paper, parchment paper, or other like materials may be applied over the layer of adhesive to form a removeable protective backing that maintains the adhesive characteristics until the decal is used. The sheet of material used to form the decal and the backing may then be cut into the shape of the decal. To apply the decal to, for example, the shoe 100, a user may remove the backing from the decal. The user may position the decal over the desired location of the shoe 100 with the adhesive side of the decal facing the shoe 100. The user may press the decal onto the shoe 100, thereby activating the adhesive and bonding the decal to the shoe 100. In one or more cases, the decal having the pressure sensitive adhesive may be detached and reattached to the shoe 100, allowing the user to re-position the decal on the shoe 100. The decal may adhere to one or more surfaces of the shoe 100 for a period of time, such as, but not limited to, one year or about one year. The decal may be removed from the one or more surfaces of the shoe 100 without leaving adhesive residue on the surfaces of the shoe 100.

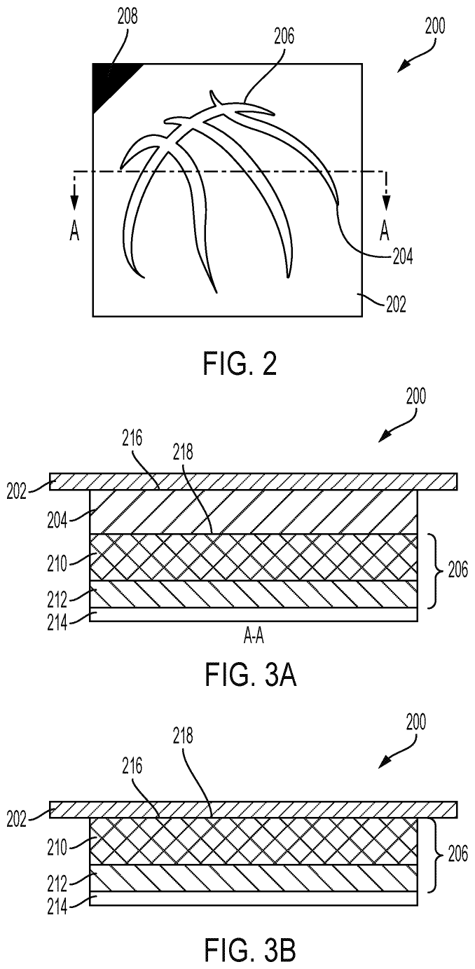

FIG. 2 illustrates a perspective view of an alignment application system 200 including an example decal layer 206. FIG. 3A illustrates an example cross-sectional side view taken along section A-A of the example alignment application system 200 of FIG. 2. It is noted that decal layer 206 includes one or more of the same or similar features as those described with respect to decals 104, 110, and 116. Accordingly, a description of such features is not repeated. Further, although the examples described herein relate to the decal layer 206 being applied to a shoe, it is noted that the decal layer 206 may be applied to other apparel, such as, but not limited to, clothing, fashion accessories, drinkware, bags, hats, and the like. Moreover, it is noted that the alignment application system 200 may be used to apply decals 104, 110, and 116 to shoe 100.

In one or more cases, the alignment application system 200 includes a first layer 202, a second layer 204, a decal layer 206, and a backing layer 214. The first layer 202 may be positioned on the second layer 204. The second layer 204 may be positioned on the decal layer 206. The decal layer 206 may include a material layer 210 and an adhesive layer 212. The material layer 210 may be positioned on the adhesive layer 212. The decal layer 206 may be positioned on the backing layer 214.

In one or more cases, the first layer 202 may be a flexible non-stick material that is configured to maintain the shape of the decal. For instance, the first layer 202 may include a plastic non-stick material that maintains the shape of the decal while the decal is being positioned on a shoe. As such, the first layer 202 prevents the decal from being inadvertently wrinkled or deformed when aligning and applying the decal to the shoe. In one or more cases, the material of the first layer 202 may be transparent (e.g., see-through) to allow a user to accurately align the decal onto an area of the shoe 100. In one or more cases, the first layer 202 includes a tab 208 that includes a material that is more rigid than the remaining area of the first layer 202. The tab 208 may provide an area that allows a user to grip and peel the first layer 202 and the second layer 204 off the decal layer 206.

In one or more cases, the second layer 204 may be positioned between the first layer 202 and the decal layer 206. The surface 216 of the second layer 204 that contacts the first layer 202 may be coated with an adhesive that permanently bonds the second layer 204 to the first layer 202. The surface 218 of the second layer 216 that contacts the decal layer 206 may be coated with an adhesive that temporarily bonds the second layer 204 to the decal layer 206. In one or more cases, during the application process, as a user removes the first layer 202 from the system 200 and in turn the shoe, the second layer 204 separates from the decal layer 206 while maintaining contact with the first layer 202. Having separated the first layer 202 and second layer 204 from the decal layer 206, the material layer 210 of the decal layer 206 is exposed. In one or more cases, the second layer 204 may include the same shape or a substantially similar shape as the decal layer 206. As such, the first layer 202 and the second layer 204 allow a user to align and preview the position of the decal layer 206 onto the shoe 100 before adhering the decal layer 206 to the shoe 100.

The decal layer 206 includes a material layer 210 and an adhesive layer 212. The material layer 210 may provide the shape of the decal. The material layer 210 may be formed from a material, such as, but not limited to leather, faux and/or vegan leather, synthetic leather suede, vinyl, canvas, flexible plastic, rubber, and/or foam materials, such as polyurethane, low-density polyethylene, thermal plastic rubber, ethylene-vinyl acetate, and the like. In one or more cases, the material layer 210 may be flexible enough to conform to the various contours and elevated surfaces of a shoe, such as shoe 100, yet rigid enough to lie smoothly along the various surfaces and materials of the shoe without bunching or wrinkling.

The adhesive layer 212 may be, for example, but not limited to, pressure sensitive adhesive. The adhesive layer 212 may allow the material layer 210 to be detached and reattached to an object, such as shoe 100, allowing the user to re-position the material layer 210 on the object. The adhesive layer 212 may adhere the material layer 210 to the object for a period of time, such as, but not limited to, one year or about one year. In one or more cases, the adhesive layer 212 may be formed of an adhesive material that may be removed from a surface of an object, such as the one or more surfaces of shoe 100, without leaving adhesive residue on the surface of the object.

The backing layer 214 may be removably coupled to the decal layer 206, and in particular, the adhesive layer 212. The backing layer 214 may be formed of a material such as wax paper, parchment paper, or other like materials that may be removed from the adhesive layer 212. In one or more cases, the backing layer 214 may be formed of the same material as the first layer 202. The backing layer 214 may form a removeable protective barrier that allows the adhesive layer 212 to maintain its adhesive characteristics until the decal layer 206 is ready to be applied to an object.

To assemble the alignment application system 200, an adhesive substance forming the adhesive layer 212 is applied to either a sheet of material forming the backing layer 214 or a sheet of material forming the material layer 210. For the cases in which the adhesive substance forming the adhesive layer 212 is applied to the sheet of material forming the backing layer 214, the sheet of material forming the material layer 210 is then applied to the adhesive substance forming the adhesive layer 212. For the cases in which the adhesive substance forming the adhesive layer 212 is applied to the sheet of material forming the material layer 210, the sheet of material forming the backing layer 214 is then applied to the adhesive substance forming the adhesive layer 212.

In one or more cases, the surface 218 of the sheet of material forming the second layer 204 is coated with an adhesive that temporarily bonds the sheet of material forming the second layer 204 to the sheet of material forming the material layer 210. The coated surface 218 of the sheet of material forming the second layer 204 is then positioned on the sheet of material forming the material layer 210, thereby bonding the sheet of material forming the second layer 204 to the sheet of material forming the material layer 210. It is noted that the sheet of material forming the second layer 204 may be bonded to the sheet of material forming the material layer 210 either before or after the sheet of material forming the material layer 210 and the sheet of material forming the backing layer 214 are bonded to one another via the adhesive substance forming the adhesive layer 212.

The shape of the decal layer 206 may be formed, for example, via die cutting, laser cutting, and other like cutting processes that correspond to the type of materials forming the alignment application system 200, such as the material layer 210. For instance, a die cutting process may be used to form the decal shape in leather or vegan leather that forms the material layer 210. In another instance, a laser cutting process or die cutting process may be used to form the decal shape in polyurethane material that forms the material layer 210. When cutting the decal layer 206 into a shape of a decal, the cutting process may include simultaneously cutting the second layer 204, material layer 210, adhesive layer 212, and the backing layer 214 into the shape of the decal. For instance, the second layer 204, material layer 210, adhesive layer 212, and the backing layer 214 may be cut into a shape forming the seams of a basketball. It is noted that although FIG. 2 illustrates the decal is shaped in the form of basketball seams, it should be understood that the decal may be formed into a variety of shapes.

Having created the shape of the decal, the surface 216 of the second layer 204 may be coated with an adhesive that permanently bonds the second layer 204 to the first layer 202. The first layer 202 may be formed in a shape that is larger than the shape of the decal. The first layer 202 may be positioned on the coated surface 216 of the second layer 204, thereby permanently bonding the second layer 204 to the first layer 202.

FIG. 3B illustrates an example cross-sectional side view taken along section A-A of the example alignment application system 200 of FIG. 2. In one or more cases, the alignment application system 200 includes a first layer 202, a decal layer 206, and a backing layer 214. The first layer 202 may be positioned on the decal layer 206. The decal layer 206 may include a material layer 210 and an adhesive layer 212. The material layer 210 may be positioned on the adhesive layer 212. The decal layer 206 may be positioned on the backing layer 214.

In one or more cases, the first layer 202 may be a flexible non-stick material that is configured to maintain the shape of the decal. For instance, the first layer 202 may include a plastic non-stick material that maintains the shape of the decal while the decal is being positioned on a shoe. As such, the first layer 202 prevents the decal from being inadvertently wrinkled or deformed when aligning and applying the decal to the shoe. In one or more cases, the material of the first layer 202 may be transparent (e.g., see-through) to allow a user to accurately align the decal onto an area of the shoe 100. In one or more cases, the first layer 202 includes a tab 208 that includes a material that is more rigid than the remaining area of the first layer 202. The tab 208 may provide an area that allows a user to grip and peel the first layer 202 off the decal layer 206.

A surface of the first layer 216 that contacts the decal layer 206 may be coated with an adhesive that temporarily bonds the first layer 202 to the decal layer 206. In one or more cases, during the application process, as a user removes the first layer 202 from the system 200 and in turn the shoe, the first layer 202 separates from the decal layer exposing the material layer 210 of the decal layer 206.

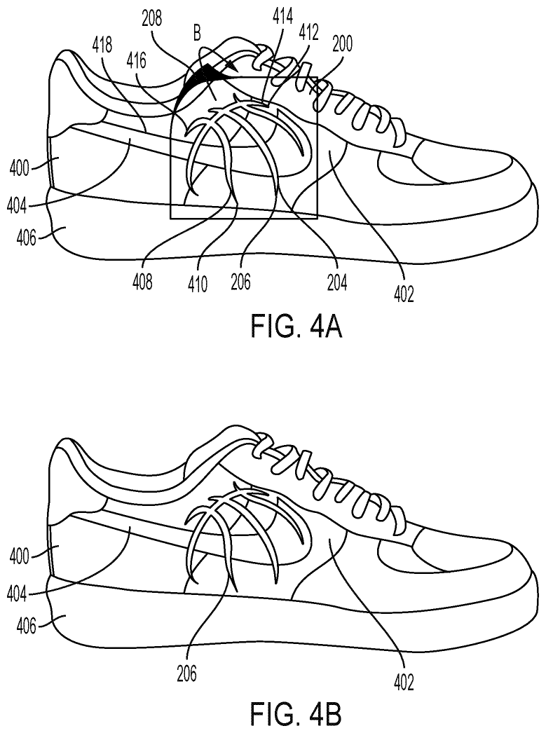

FIGS. 4A and 4B illustrate an example application of applying a decal to an object via the alignment application system 200. Conventional decal shapes may have a plurality of intricate areas (e.g., seams 408, 412, and 416) that require the user to individually apply these areas of the decal to the shoe 400. These areas may sometimes be small and difficult to grasp when individually applying these areas to the shoe 400. Moreover, these areas may be formed in irregular shapes, further increasing the difficulty in applying these areas to the shoe 400. As such, these areas of conventional decals are generally not applied to the intended position, stick to one another, and/or wrinkle. In contrast to conventional decals, the alignment application system 200 allows a user to apply these areas in a uniform manner, such that the areas are positioned on the intended areas of the shoe 400 while not sticking to one another or wrinkling.

To apply a decal via the alignment application system 200, a user first removes the backing layer 214 to expose the adhesive layer 212 of the decal layer 206. The user may grasp any portion or portions of the first layer 202 to align the decal layer 206 over a portion of the shoe 400. As the first layer 202 is see-through and the second layer 204 provides a preview of the placement of the decal layer 206, the user can align the decal layer 206 to particular areas of the shoe 400 before adhering the decal layer 206 to the shoe 400. For example, the tip of the first seam 408 may be aligned with an edge 410 of the sole 406, the tip of the second seam 412 may be aligned with the edge 414 of the quarter panel 402, and the tip of the third seam 416 may be aligned with the edge 418 of the logo 404. By aligning these areas of the seams with the corresponding areas of the shoe 400, the seams of the decal appear to surround and hug the logo 404 providing a unique and customized shoe.

Having aligned the areas of the decal layer 206 over the shoe 400, the user may press the adhesive layer 212 of the decal layer 206 against the surface of the shoe 400. The user may press the adhesive layer 212 against one or more surfaces of the shoe 400 for a period of time, such that the adhesive is activated and bonds the material layer 210 to the one or more surfaces of the shoe 400. The user may then peel back the first layer 202 to separate the first layer 202 and second layer 204 from the decal layer 206. For example, the user may grasp the tab 208 of the first layer 202, and peel back the tab 208 in direction B, such that the second layer 204 separates from the material layer 210 of the decal layer 206, as illustrated in FIG. 4B.

The foregoing is provided for the purpose of illustrating, explaining, and describing embodiments of this disclosure. While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure.

What is claimed is:

1. A pressure sensitive decal configured to adhere to footwear, comprising:
a flexible three-dimensional material formed in a shape, wherein a rear surface of the material comprises a pressure sensitive adhesive configured to removably couple the material to one or more surfaces of the footwear, and
a backing removably coupled to a rear surface of the material via the pressure sensitive adhesive, wherein the backing is configured to maintain adhesive characteristics of the pressure sensitive adhesive,
wherein the material is configured to adhere and conform to one or more surfaces of the footwear, such that the material lies smoothly along the one or more surfaces without deforming the shape of the decal, and
wherein the one or more surfaces comprise one or more types of materials.

2. The decal of claim 1, wherein the material comprises one of leather, faux leather, vegan leather, synthetic leather, suede, vinyl, canvas, flexible plastic, rubber, or a foam material.

3. The decal of claim 1, wherein the material is further configured to adhere and conform to a first surface and a second surface of the footwear, and wherein the first surface of the footwear is disposed at a first angle respective to the footwear and the second surface of the footwear is disposed at a second angle respective to the footwear.

4. The decal of claim 3, wherein the first surface is disposed at a farther distance from the second surface of the footwear, such that elevations of the first surface and second surface are different.

5. The decal of claim 1, wherein the material is further configured to adhere and conform to a first surface and a second surface of the footwear, and wherein the first surface is disposed at a farther distance from the second surface of the footwear, such that elevations of the first surface and second surface are different.

6. The decal of claim 1, wherein the shape of the material is formed via a die cutting process or laser cutting process.

7. The decal of claim 1, wherein the material is configured to adhere, via the pressure sensitive adhesive, to one or more surfaces of the footwear for at least a year.

8. The decal of claim 7, wherein the material is configured to be removed from the one or more surfaces of the footwear without leaving residue of the pressure sensitive adhesive.

9. A decal alignment application system, comprising:
a first layer comprising a flexible non-stick material permanently coupled to a second layer;
the second layer having a first surface coated in an adhesive that permanently couples the second layer and the first layer, and a second surface coated in an adhesive that temporarily bonds the second layer and a decal layer;
the decal layer comprising a material layer and an adhesive layer, wherein the material layer comprises a flexible three-dimensional material formed in a shape of a decal, wherein the adhesive layer comprises a pressure sensitive adhesive configured to removeable coupled to a backing layer; and
the backing layer removably coupled to the adhesive layer of the decal layer and is configured to maintain adhesive characteristics of the pressure sensitive adhesive of the adhesive layer,
wherein the material layer is configured to adhere and conform, via the adhesive layer, to one or more surfaces of footwear, such that the material layer lies smoothly along the one or more surfaces without deforming the shape of the decal.

10. The decal alignment application system of claim 9, wherein the material layer comprises one of leather, faux leather, vegan leather, synthetic leather, suede, vinyl, canvas, flexible plastic, rubber, or a foam material.

11. The decal alignment application system of claim 9, wherein the material layer is further configured to adhere and conform to a first surface and a second surface of the footwear, and wherein the first surface of the footwear is disposed at a first angle respective to the footwear and the second surface of the footwear is disposed at a second angle respective to the footwear.

12. The decal alignment application system of claim 11, wherein the first surface is disposed at a farther distance from the second surface of the footwear, such that elevations of the first surface and second surface are different.

13. The decal alignment application system of claim 9, wherein the material layer is further configured to adhere and conform to a first surface and a second surface of the footwear, and wherein the first surface is disposed at a farther distance from the second surface of the footwear, such that elevations of the first surface and second surface are different.

14. The decal alignment application system of claim 9, wherein the first layer comprises a tab configured to facilitate the uncoupling of the second layer and the decal layer.

15. The decal alignment application system of claim 9, wherein the first layer comprises a transparent material.

16. A decal alignment application system, comprising:
a first layer comprising a flexible material having a second surface coated in an adhesive that temporarily bonds the first layer and a decal layer;
the decal layer comprising a material layer and an adhesive layer, wherein the material layer comprises a flexible three-dimensional material formed in a shape of a decal, wherein the adhesive layer comprises a pressure sensitive adhesive configured to removeable coupled to a backing layer; and
the backing layer removably coupled to the adhesive layer of the decal layer and is configured to maintain adhesive characteristics of the pressure sensitive adhesive of the adhesive layer,
wherein the material layer is configured to adhere and conform, via the adhesive layer, to one or more surfaces of footwear, such that the material layer lies smoothly along the one or more surfaces without deforming the shape of the decal.

17. The decal alignment application system of claim 16, wherein the material layer comprises one of leather, faux leather, vegan leather, synthetic leather, suede, vinyl, canvas, flexible plastic, rubber, or a foam material.

18. The decal alignment application system of claim 16, wherein the material layer is further configured to adhere and conform to a first surface and a second surface of the footwear, and wherein the first surface of the footwear is disposed at a first angle respective to the footwear and the second surface of the footwear is disposed at a second angle respective to the footwear.

19. The decal alignment application system of claim 18, wherein the first surface is disposed at a farther distance from the second surface of the footwear, such that elevations of the first surface and second surface are different.

20. The decal alignment application system of claim 16, wherein the material layer is further configured to adhere and conform to a first surface and a second surface of the footwear, and wherein the first surface is disposed at a farther distance from the second surface of the footwear, such that elevations of the first surface and second surface are different.
